(19) United States
(12) Patent Application Publication
(10) Pub. No.: US 2012/0125335 A1
(43) Pub. Date: May 24, 2012

(54) Cool Air Breathing Apparatus

(75) Inventor: Frank Affinito, Belleflower, CA (US)

(73) Assignee: Core Cooler, LLC

(21) Appl. No.: 13/356,543

(22) Filed: Jan. 23, 2012

Related U.S. Application Data
(63) Continuation-in-part of application No. 29/378,844, filed on Nov. 10, 2010.
(60) Provisional application No. 61/435,237, filed on Jan. 21, 2011.

(51) Int. Cl. A62B 7/00

(52) U.S. Cl. 128/204.15

(57) ABSTRACT

A Cool Air Breathing Apparatus. The apparatus provides a low-cost, comfortably-sized, convenient source of cool breathing air to a use. The apparatus id attachable to a standard-sized water bottle container, such as is used for bicycles and exercising in general. The user is able to simply fill the water bottle container with a cooling material, and then breathe through a mouthpiece in order to receive cooling air. The cooling material could be cold liquid, ice cubes or chips, or even a solid frozen block. There is also a folding mouthpiece so that the user can seal the container when it is not in use.

This application is filed within one year of, and claims priority to Provisional Application Ser. No. 61/435,237, filed Jan. 21, 2011.

This application is a continuation in part of application Ser. No. 29/378,844, filed Nov. 10, 2010, now pending.

### BACKGROUND OF THE INVENTION

1. Field of the Invention

This invention relates generally to personal devices for treating breathing air and, more specifically, to a Cool Air Breathing Apparatus.

2. Description of Related Art

There are a variety of prior personal air treatment devices that are intended to solve a variety of articulated problems related to personal respiratory issues. A very relevant design is disclosed by Carrier, U.S. Pat. App. Pub. US09/0229609. Carrier depicts a “Portable, Disposable Cool Air Inhaler,” purportedly to be used to treat the user's throat and mouth area with cool air. While the device of Carrier appears to be a reasonable attempt at providing the user with cool breathing air, it does so at a substantial cost. The Carrier “inhaler” incorporates a complex internal plumbing design, as well as an integrated bellows; these features result in making the product cost-prohibitive for everyday use, despite its touted recyclability.

Several other references relate to providing the user with cool air to breathe, but are even less suitable to solving the problem solved by the instant invention than was Carrier. F. M. Gleockler, U.S. Pat. No. 3,140,590 discloses an air-conditioning facemask. The Gleockler device, while apparently functional, is bulky and requires that a full face mask be worn in order to obtain breathing relief. Pasternack, U.S. Pat. No. 4,188,947 is also designed to provide its users with a portable cooling source, but requires that the user strap the device over his or her back. Finally, Horn, U.S. Pat. No. 5,542,413 also discloses a “Personal Cooling Apparatus.” Like Pasternack, Horn requires that the user strap the device over his or her back, such that an internal cooling pack rests against the kidney. Furthermore, like Gleockler, Horn has a facemask that the user must wear.

As discussed individually above, each of these prior devices marginally provides the benefits of providing a portable cool breathing air source to the user. The problem with all of them, however, is that they are simply too complex and/or bulky (and expensive) for them to be economically feasible for everyday use by the general population. What is needed is a cool air breathing apparatus that provides this portable cool air source, but is convenient and inexpensive enough for it to be used by virtually anyone.

### SUMMARY OF THE INVENTION

In light of the aforementioned problems associated with the prior devices, it is an object of the present invention to provide a Cool Air Breathing Apparatus. The apparatus should provide a low-cost, comfortably-sized, convenient source of cool breathing air to a use. The apparatus should be attachable to a standard-sized water bottle container, such as is used for bicycles and exercising in general. The user should simply be able to fill the water bottle container with a cooling material, and then breathe through a mouthpiece in order to receive cooling air. The cooling material could be cold liquid, ice cubes or chips, or even a solid frozen block. There should be a folding mouthpiece so that the user can seal the container when it is not in use.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the cool air breathing apparatus of the present invention;

FIG. 2 is a perspective view of the apparatus of FIG. 1, further displaying the internal elements of the design;

FIG. 3 is an exploded side view of the apparatus of FIGS. 1 and 2;

FIG. 4 is an exploded perspective view of the apparatus of FIGS. 1-3; and

FIG. 5 is an exploded perspective view of an alternate embodiment of the apparatus of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Cool Air Breathing Apparatus.

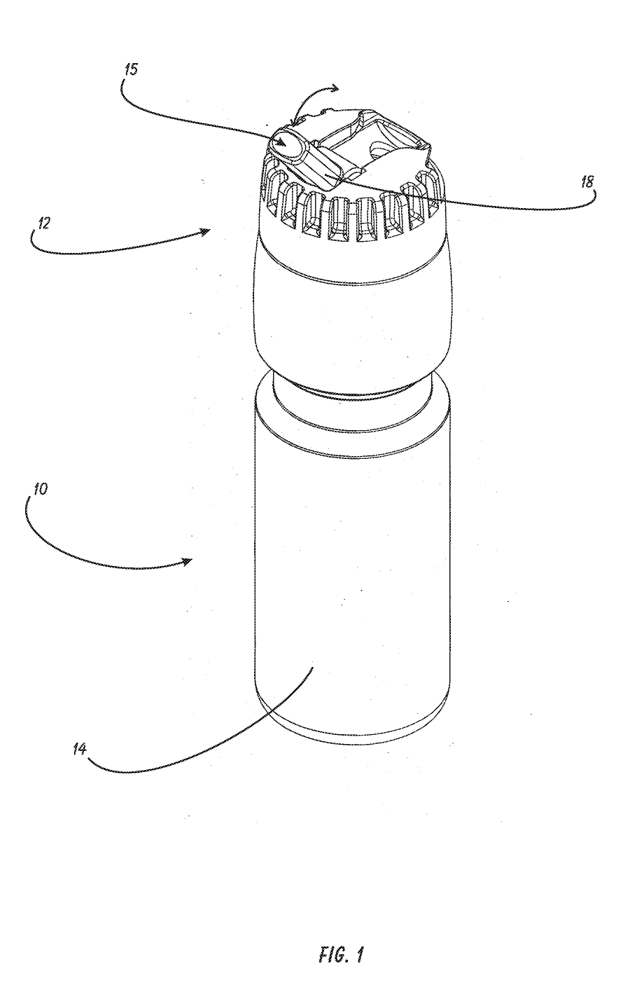

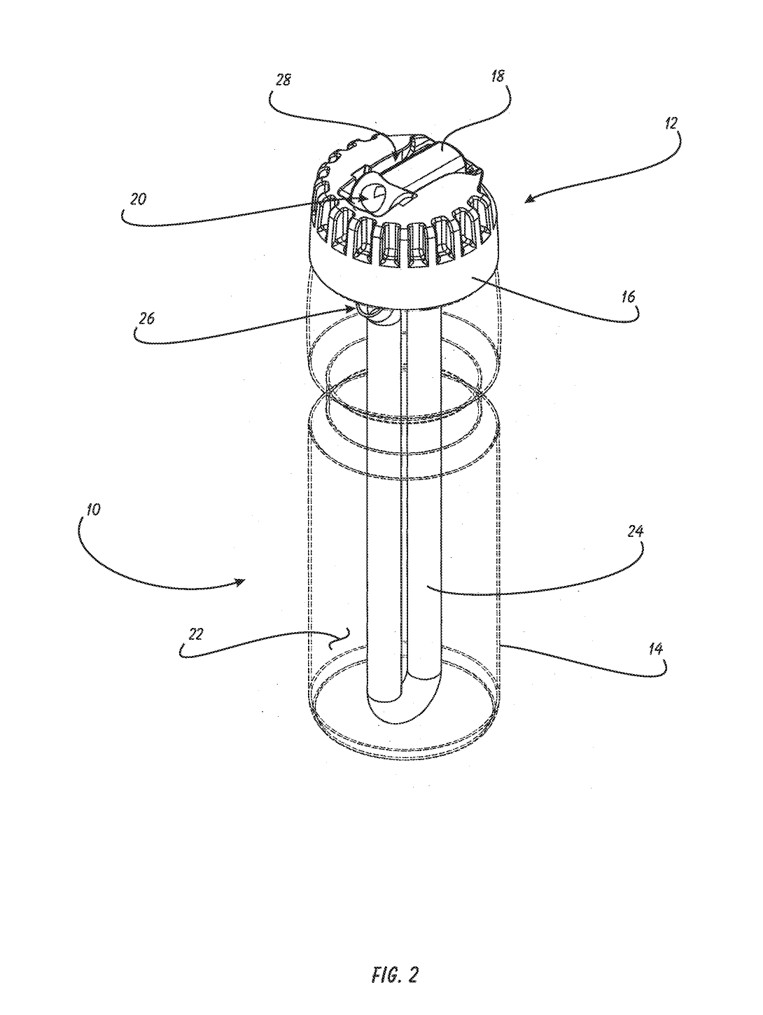

The present invention can best be understood by initial consideration of FIG. 1. FIG. 1 is a perspective view of a preferred embodiment of the cool air breathing apparatus of the present invention. The cool air breathing apparatus 10 is shaped much like a conventional sport beverage bottle, at least from outward appearances. It is the internal features that distinguish the apparatus 10 from those conventional drinking bottles. The head assembly 12 threadedly engages the top opening formed on the cool air breathing apparatus 10. The assembly 12 has a tubular mouthpiece 18 that can be flipped up and down in the direction of the arrow shown. When flipped up as shown in this FIG. 1, the outer port 15 is exposed so that the user can place his or her mouth upon it. The lower housing 14 is shaped essentially the same as many conventional sport bottles such as those designed for use with bicycles. FIG. 2 provides additional features related to this novel design.

FIG. 2 is a perspective view of the apparatus of FIG. 1, further displaying the internal elements of the design. The head assembly as shown in this view comprises an upper housing 16 to which the mouthpiece 18 attaches. Here the mouthpiece 18 has been flipped down into the stowed position, and as can be seen, the inner port 20 is exposed. There are one or more air intake apertures 28 formed in the top of the upper housing 16. These intake apertures are sealed when the mouthpiece 18 is folded down into this position shown.

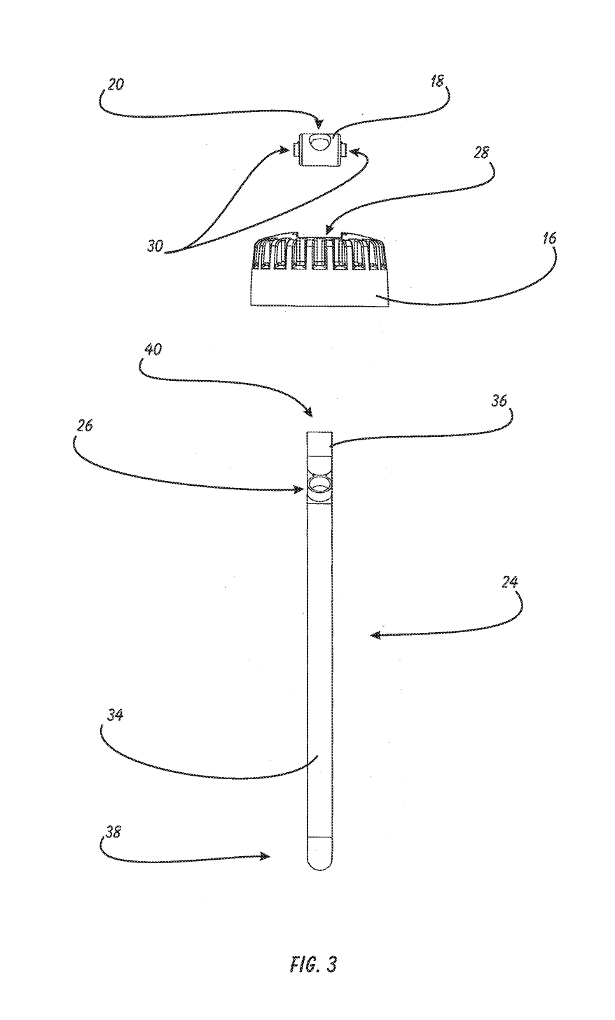

Within the lower housing 14, there is a U-shaped draw tube 24 that connects to the head assembly 12 on its bottom side, such that the inner port 20 is in fluid communication with the interior of the draw tube 24 when the mouthpiece 18 is flipped up in the position shown in FIG. 1. At the distal end of the draw tube 24 is located an air intake port 26. The air intake port is located such that when the cool air breathing apparatus 10 is assembled, the intake port 26 will be located near the top edge of the lower housing 14 so that it remains above any liquid that might reside within the coolant chamber 22. It should be appreciated if cool liquid and/or ice or other cold materials are placed within the coolant chamber 22 to surround the draw tube 24, the user need simply flip up the mouthpiece 18 as shown in FIG. 1 and begin to breathe in, sucking air through the draw tube 24 and the mouthpiece 18. As the air flows through the draw tube 24, it should be clear that the incoming air will be cooled measurably thereby providing the user with a refreshing, cooling air source that is particularly effective at cooling down the individual's core in circumstances when the user has become overheated due to exercise or environmental conditions. We will now turn to FIG. 3 to continue to examine the features of this device.

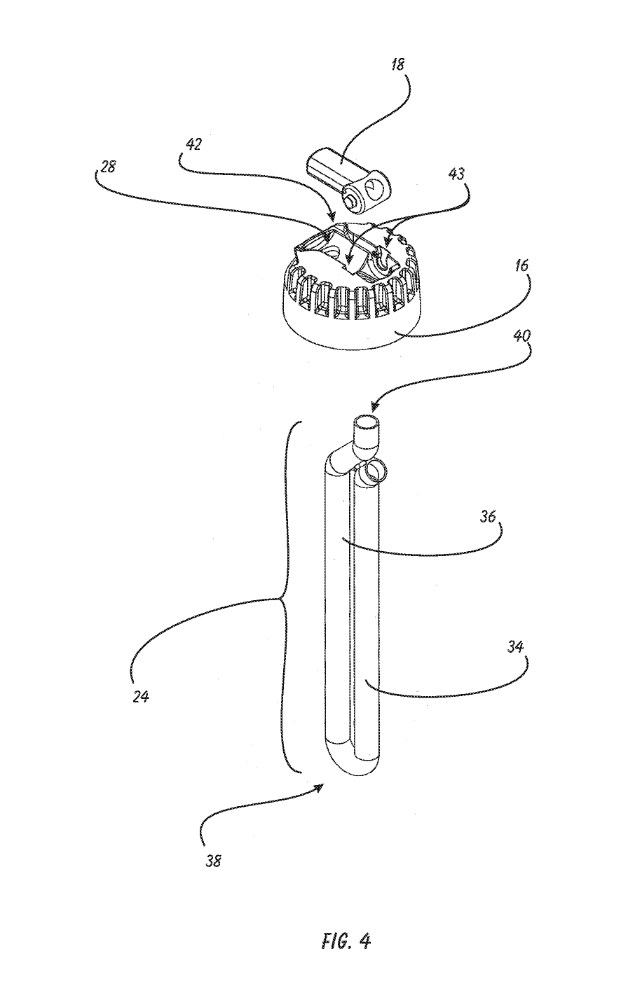

FIG. 3 is an exploded side view of the apparatus of FIGS. 1 and 2. In this view the draw tube 24 can be seen as comprising a distal tube portion 34 and a proximal tube portion 36. The distal tube portion 34 and proximal tube portion 36 are interconnected by elbow 38. Distal tube portion 34 terminates at its distal end at air intake port 26. Similarly proximal tube portion 36 terminates at its upper end at housing interface port 40. By its name we can see that the housing interface port 40 is configured to insert into the upper housing 16 such that the interior of the mouthpiece 18 is in fluid communication with the interface port 40. The mouthpiece 18 is actually a separate element that preferably snaps into a pair of recesses formed in the top of the upper housing 16. The mouthpiece 18 is permitted to rotate around a pair of axle prongs 30 extending from opposite sides of the mouthpiece 18. As discussed previously, one or more air intake apertures 28 are formed in the recessed area within which the mouthpiece 18 resides when flipped down and these apertures 28 permit air to enter into the coolant chamber through the upper housing so that when the user is sucking on the mouthpiece 18, air will be permitted to enter the coolant chamber 22 and consequently into the air intake point 26. FIG. 4 gives another view of this device from another angle.

FIG. 4 is an exploded perspective view of the apparatus of FIGS. 1-3. As shown here, the upper housing 16 has a mouthpiece cavity 42 formed in its top. Within the mouthpiece cavity 42 are the air intake apertures 28 and furthermore a pair of axle slots 43 configured to accept the axle prongs 30 therein. The draw tube 24 in this version is designed so that upper end of the proximal tube portion is actually co-linear with the distal tube portion 34. The curves making up the various sections of the draw tube 24 are designed to provide as little restriction to airflow as possible so that when the user draws on the mouthpiece 18, he or she does not experience discomfort or restrictions to their breathing. The draw tube 24 is detachable from the upper housing 16 for manufacturing and/or for cleaning. Other designs and configurations of the draw tube 24 may be provided including spiral versions or other configurations of tubing. What is critical is that cool air breathing apparatus 10 is designed to be much less expensive than the prior art systems and very convenient for use so that it is handy and available whenever a potential user becomes overheated. The fact that it can be designed to match the outer dimensions of a conventional sports water bottle means that it will be very easily adopted by a wide range of users.

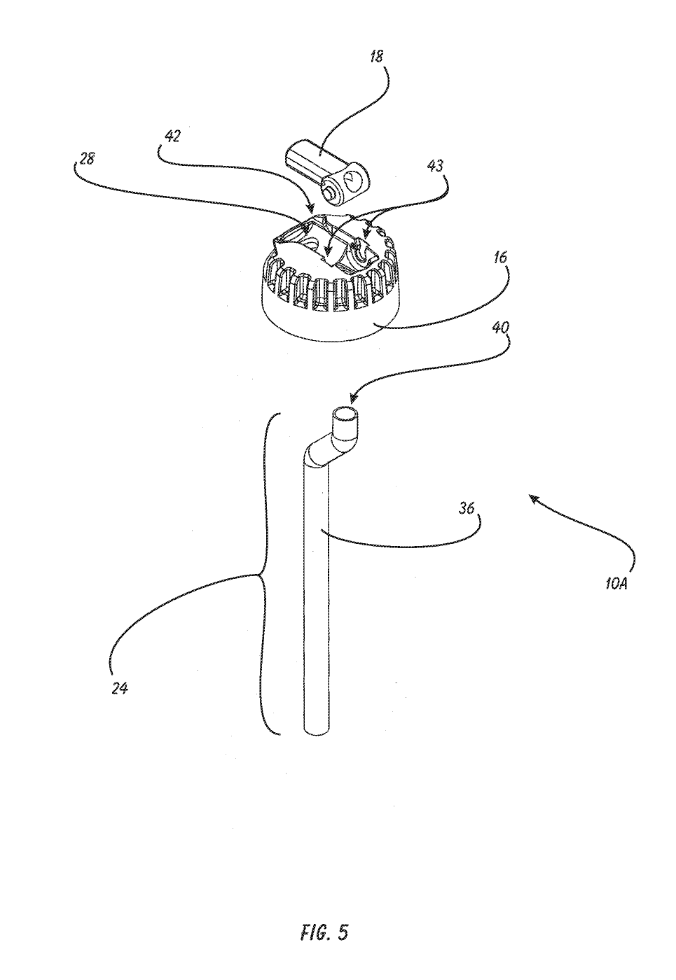

FIG. 5 is an exploded perspective view of an alternate embodiment of the apparatus 10A of the present invention. This version is for use when crushed or cubed ice is placed within the lower housing. Essentially, in this version, there is no elbow or distal tube portion; there is only a proximal tube portion 36 making up the draw tube 24. Although not shown here, it is expected that in many versions, there will be a plurality of slits or apertures formed through the walls of the draw tube 24, which will allow air to be drawn in through the sides of the draw tube 24 when the user sucks on the mouthpiece 18. The incoming air will pass through the surrounding ice before entering the tube 24, and will thereby be cooled nicely.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A cool air breathing apparatus, comprising:
a lower housing defining an internal coolant chamber and having an upper opening into said chamber;
an upper housing attachable to seal said upper opening, said upper housing defined by a draw port formed therethrough; and
a draw tube having an upper interface port in fluid communication with said draw port, said draw port extending from said upper housing and into said coolant chamber.

2. The apparatus of claim 1, further comprising a head assembly, said head assembly comprising said upper housing and a mouthpiece extending therefrom, said mouthpiece attachable to said draw port.

3. The apparatus of claim 2, wherein said upper housing is defined by a cavity formed in a top face, said cavity and said mouthpiece cooperatively formed such that said mouthpiece is received within said cavity.

4. The apparatus of claim 3, wherein said cavity comprises a pair of axle slots formed in opposing sides thereof and said mouthpiece comprise a pair of axle prongs extending outwardly therefrom, whereby said axle prongs are accepted into said axle slots when said mouthpiece is received within said cavity.

5. The apparatus of claim 4, wherein said upper housing comprises at least one air intake aperture formed therethrough, each said air intake aperture in fluid communication with said internal coolant chamber when said upper housing is attached to seal said lower housing.

6. The apparatus of claim 5, wherein said draw tube comprises an elongate hollow tube extending between said upper interface port at a first end and an air intake port at a second end.

7. The apparatus of claim 6, wherein said draw tube comprises a proximal tube portion and a distal tube portion interconnected by an elbow, said proximal tube portion terminating in said upper interface port and said distal tube portion terminating in said air intake port.

8. The apparatus of claim 7, wherein said draw tube forms a “U” shape defined by said substantially parallel distal and proximal tube portion interconnected by said elbow, with said draw tube being encapsulated by said lower housing in said internal coolant chamber when said upper housing is attached to seal said opening in said lower housing.

9. A breathing air cooling assembly, comprising:
a lower housing defining an internal coolant chamber and having a bottom closed end and an open opposing end;
an upper housing attachable to seal said open end, said upper housing defined by a draw port formed therethrough; and
a draw tube having an upper interface port in fluid communication with said draw port, said draw port extending from said upper housing and into said coolant chamber.

10. The assembly of claim 9, wherein said draw tube comprises an elongate hollow tube extending between an upper interface port formed through said upper housing at a first end and an air intake port at a second end.

11. The assembly of claim 10, wherein said draw tube comprises a proximal tube portion and a distal tube portion interconnected by an elbow, said proximal tube portion terminating in said upper interface port and said distal tube portion terminating in said air intake port.

12. The assembly of claim 11, wherein said draw tube forms a “U” shape defined by said substantially parallel distal and proximal tube portion interconnected by said elbow, with said draw tube being encapsulated by said lower housing in said internal coolant chamber when said upper housing is attached to seal said opening in said lower housing.

13. The assembly of claim 12, further comprising a head assembly, said head assembly comprising said upper housing and a mouthpiece extending therefrom, said mouthpiece pivotally interconnectable to said draw port.

14. The assembly of claim 13, wherein said upper housing is defined by a cavity formed in a top face, said cavity and said mouthpiece cooperatively formed such that said mouthpiece is received within said cavity.

15. The assembly of claim 14, wherein said cavity comprises a pair of axle slots formed in opposing sides thereof and said mouthpiece comprise a pair of axle prongs extending outwardly therefrom, whereby said axle prongs are accepted into said axle slots when said mouthpiece is received within said cavity to facilitate said pivotal movement to connect and disconnect said mouthpiece to and from said draw port.

16. The assembly of claim 15, wherein said upper housing comprises at least one air intake aperture formed therethrough, each said air intake aperture in fluid communication with said internal coolant chamber when said upper housing is attached to seal said lower housing.

17. A cool air breathing apparatus for attaching to a bottle, said bottle defined by an outer wall having a closed bottom and open top and forming an internal chamber, said breathing apparatus comprising:
a head assembly, comprising:
an upper housing attachable to seal said bottle open top;
a mouthpiece extending from an outer face of said upper housing, said mouthpiece having an outer port at one end and an inner port at an opposing end; and
a draw tube extending from an inner face of said upper housing such that said draw tube is encapsulated within the internal chamber when said upper housing is attached to seal said bottle open top, the interior of said draw tube in fluid communication with said inner port.

18. The assembly of claim 17, wherein said draw tube comprises an elongate hollow tube extending between an upper interface port formed through said upper housing at a first end and an air intake port at a second end, said upper interface port in fluid communication with said inner port when said mouthpiece is place in a first position.

19. The apparatus of claim 18, wherein said draw tube comprises a proximal tube portion and a distal tube portion interconnected by an elbow, said proximal tube portion terminating in said upper interface port and said distal tube portion terminating in said air intake port.

20. The assembly of claim 19, wherein said mouthpiece is pivotally attached to said upper housing between said first position and a second position whereafter there is no fluid communication between said upper interface port and said inner port.
